(19) United States
(12) Patent Application Publication
(10) Pub. No.: US 2005/0273532 A1
(43) Pub. Date: Dec. 8, 2005

(54) Memory circuit

(76) Inventors: Chen Min Chiang, Hsinchu (TW); Bryan Chih-Chen Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/862,369

(22) Filed: Jun. 8, 2004

(51) Int. Cl. G06F 13/12

(52) U.S. Cl. 710/62

(57) ABSTRACT

A memory circuit is designed for a Universal Serial Bus (USB) 2.0 circuit architecture. An analog front end unit is connected to a high-speed delay phase lock loop unit. A full-speed delay phase lock loop and data recovery unit is connected to the analog front end unit. A receiver unit is connected to the high-speed delay phase lock loop unit and the full-speed delay phase lock loop and data recovery unit. A transceiver unit is connected to the analog front end unit and the receiver unit. A control unit is connected to the transceiver unit, the receiver unit, the high-speed delay phase lock loop unit and the full-speed delay phase lock loop and data recovery unit. An external oscillator unit is connected to the control unit.

### FIELD OF THE INVENTION

The present invention relates to a memory circuit for a Universal Serial Bus (USB) 2.0 circuit architecture. The memory circuit comprises a transceiver unit, a control unit, a receiver unit, an external oscillator unit, a high-speed delay Phase Lock Loop (PLL) unit, a full-speed delay Phase Lock Loop (PLL) and data recovery unit, and an analog front end unit. The analog front end unit is connected to the receiver unit, the high-speed delay phase lock loop and the full-speed delay phase lock loop unit and data recovery unit, and a control unit, the control unit is connected to the transceiver unit, the receiver unit, the external oscillator unit, the high-speed delay Phase Lock Loop (PLL) and the full-speed delay Phase Lock Loop (PLL) and data recovery unit.

### BACKGROUND OF THE INVENTION

Universal Serial Bus (USB) was first proposed in the 1995's, and was later improved and expanded in the 1998's, to result in the universal serial bus version 1.1. The new version universal serial bus 2.0 was developed in the 2000's and is an expansion of universal serial bus 1.1 specifications. Recently, the hardware manufacturer Intel Corporation has announced support of the universal serial bus 2.0, and the software manufacturer Microsoft also has announced the Windows XP operation system to support it.

Universal serial bus 2.0 is intended to be an improvement on universal serial bus 1.1 and its architecture is based on that of the universal serial bus 1.1. The universal serial bus 2.0 maximum transmit speed is 480 Mbps, while the universal serial bus 1.1 maximum transmit speed is 12 Mbps. Therefore, the universal serial bus 2.0 maximum transmit speed is forty times greater than that of universal serial bus 1.1. The universal serial bus 2.0 has the same connect terminal and transmission line as those of the universal serial bus 1.1. It is compatible with the universal serial bus 1.1 system and universal serial bus 1.1 peripherals. The universal serial bus 2.0 also provides hot plugging interface, meaning that it allows hardware setup without restarting the computer. The universal serial bus 2.0 also supports network protocol. The universal serial bus 2.0 hub can be used to expand until 127 devices and the maximum transmit speed thereof is maintained at 480 Mbps in each device.

The application field for USBs includes computer peripherals such as keyboards, mice, printers, scanners, digital cameras, notebooks and personal digital assistants (PDA). The universal serial bus device is clearly widely used.

FIG. 1 shows a schematic diagram of the universal serial bus (USB) 2.0 receiver 100 of the prior art. A first-in first-out buffer 102 is added between the receiver 100 and static random access memory 104.

FIG. 2, shows a schematic diagram of the universal serial bus (USB) 2.0 internal circuit architecture of the prior art. According to the universal series bus specification, the universal series bus includes three input/output signals, a positive data signal 224, a negative data signal 226 and a parallel receiver data 228. This circuit sets an analog front end unit 220, an high-speed delay phase lock loop unit, a full-speed delay phase lock loop and data recovery unit 206, a flexible buffer unit 210, a multiplexer unit 212, a non-return-to-zero inverted decoder unit 214, a bit stuffer unit 216 and a receiver register unit 218. The analog front end unit further comprises a high-speed transceiver 204 and a full-speed transceiver 202. The high-speed transceiver unit further comprises a receiver unit 2040, a status/control unit 2042 and a transceiver unit 2044. The full-speed transceiver unit further comprises a receiver 2020, a status/control unit 2022 and a transceiver unit 2024. The receiver register unit further comprises a receive shift register unit 220 and a receive hold register unit 222.

The receiver unit 2020 of the full-speed transceiver 202 of the analog front end unit 200 is connected to the full-speed delay phase lock loop and data recovery unit 206. The receiver unit 2040 of the high-speed transceiver 204 of the analog front end unit 200 is connected to the high-speed delay phase lock loop unit 208. The high-speed delay phase lock loop unit 208 is connected to the flexible buffer unit 210. The full-speed delay phase lock loop and data recovery unit 206 are connected to the multiplexer unit 212. The flexible buffer unit 210 is connected to the multiplexer unit 212. The multiplexer unit 212 is connected to the non-return-to-zero inverted decoder unit 214. The non-return-to-zero inverted decoder unit 214 is connected to the bit stuffer unit 216. The bit stuffer unit 216 is connected to the receive register unit 218.

In the original universal series bus 2.0 architecture design, a flexible buffer is added between the receiver and the analog front end. The object is to adjust the transmission rate between the receiver and the analog front end. However, the buffer is disadvantageously expensive, the circuit design is complicated, and the transmission rate is slower.

### SUMMARY OF THE INVENTION

The primary technical characteristic of the present invention is to provide a memory circuit designed for Universal Serial Bus 2.0 circuit architecture. The memory circuit comprises a transceiver unit, a control unit, a receiver unit, an external oscillator unit, a high-speed delay Phase Lock Loop unit, a full-speed delay Phase Lock Loop and data recovery unit, and an analog front end unit. The analog front end unit is connected to the receiver unit, the high-speed delay phase lock loop and the full-speed delay phase lock loop unit and data recovery unit, and a control unit, the control unit is connected to the transceiver unit, the receiver unit, the external oscillator unit, the high-speed delay Phase Lock Loop and the full-speed delay Phase Lock Loop and data recovery unit.

The present invention is intended to remove a flexible buffer from original Universal Serial Bus 2.0 circuit architecture and directly connect a receiver signal to a static random access memory. When data is to be read, the receiver sends an interrupt signal to a micro processor. The micro processor notifies the static random access memory that data is read and the static random access memory opens a channel to receiver. Therefore data is directly written from receiver to the static random access memory.

In the above-mentioned, the present invention reduces the design cost, cuts down access time, eliminates transmit delay time, and simplifies circuit design.

### BRIEF DESCRIPTION OF THE DRAWINGS

The various objects and advantages of the present invention will be more readily understood from the following detailed description when read in conjunction with the appended drawing, in which:

FIG. 1 shows a schematic diagram of the universal serial bus (USB) 2.0 receiver circuit of the prior art;

FIG. 2 shows a schematic diagram of the universal serial bus (USB) 2.0 internal circuit architecture of the prior art;

FIG. 3 shows an improved schematic diagram of the receiver circuit of the present invention;

FIG. 4 shows an internal schematic diagram of the memory circuit of the present invention.

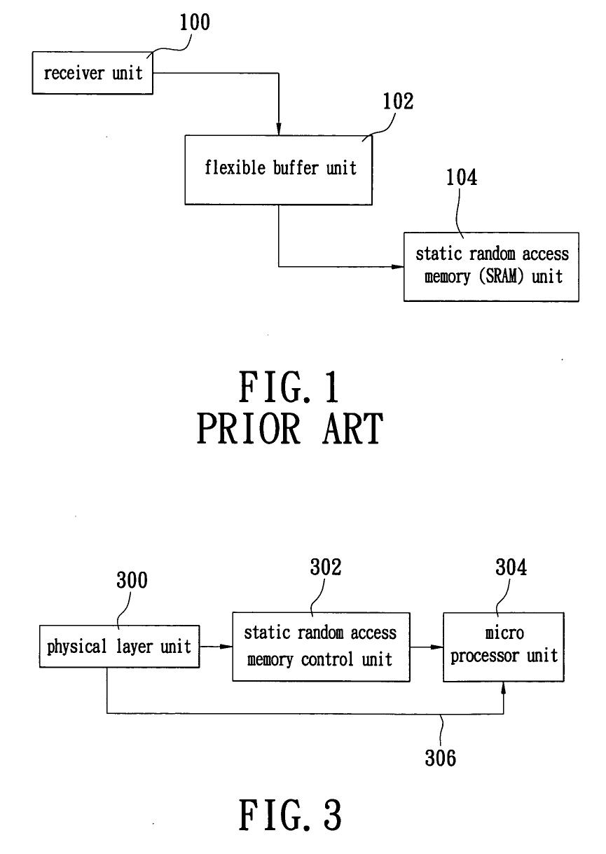

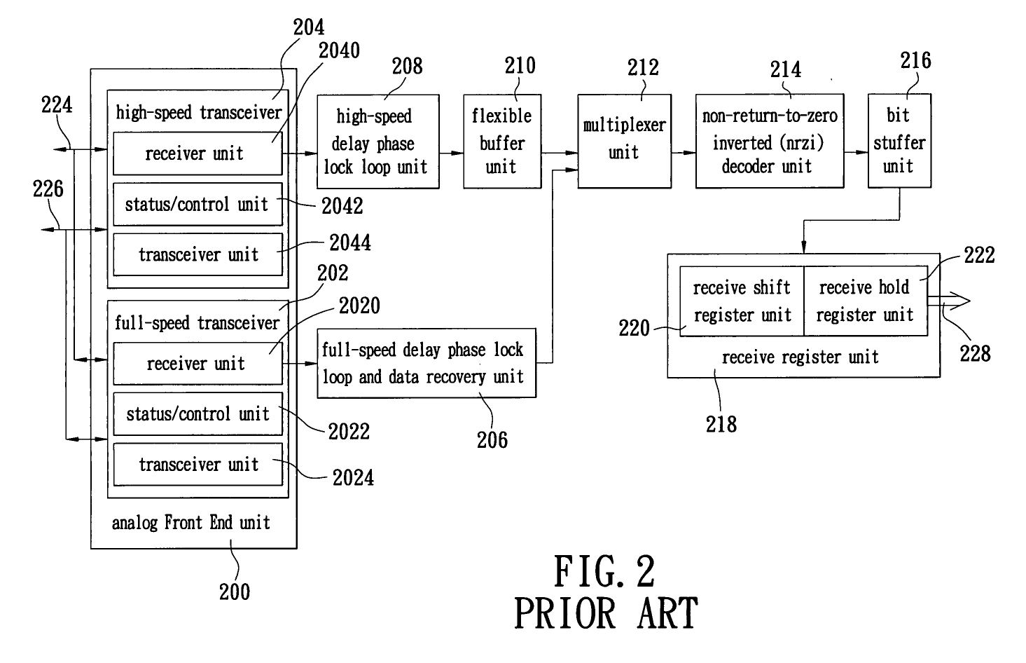

### DETAILED DESCRIPTION OF PREFERRED EMBODIMENTS

FIG. 3 shows schematic diagram of the receiver circuit of the present invention, which comprises a physical layer unit 300 and a static random access memory control unit 302. The present invention removes the first-in first-out buffer of the prior art, and directly transmits signal to the static random access memory control unit. When data is to be read, the physical layer unit directly writes all packet data to the static random access memory control unit. During data writing or after writing, the physical layer unit sends an interrupt signal to the micro-processor and the micro-processor then processes the same.

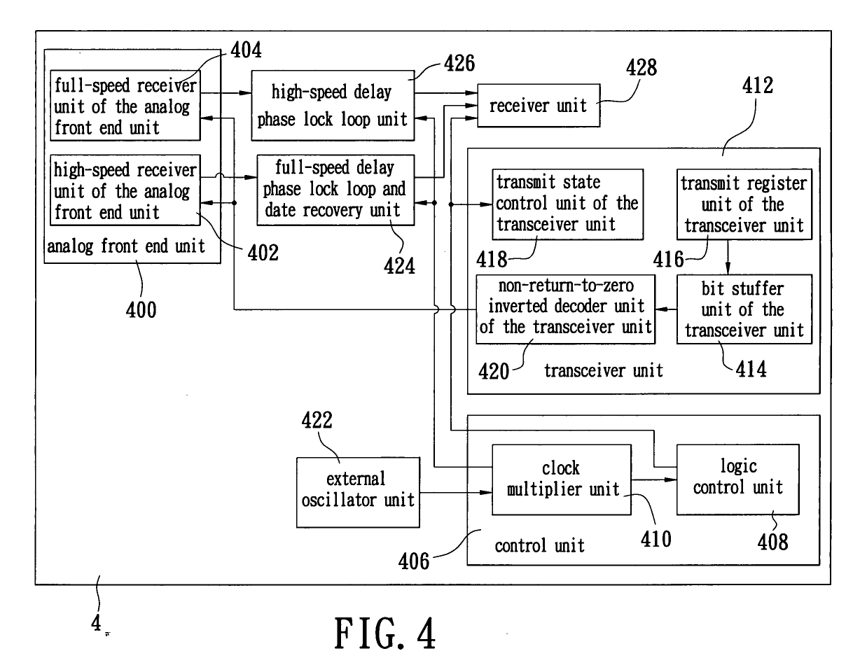

FIG. 4 shows an internal schematic diagram of the memory circuit 4 of the present invention. The memory circuit 4 comprises an analog front end unit 400, a high-speed delay phase lock loop unit 426, a full-speed delay phase lock loop and data recovery unit 424, a receiver unit 428, a transceiver unit 412, a control unit and external oscillator unit 422. The analog front end unit 400 further comprises high-speed transceiver unit 404 and a full-speed transceiver unit 402. The high-speed transceiver unit 404 is connected to the high-speed delay phase lock loop unit 426 and non-return-to-zero inverted decoder unit of the transceiver unit 420. The full transceiver unit 402 is connected to the full-speed delay phase lock loop and data recovery unit 424 and the non-return-to-zero inverted decoder unit of the transceiver unit 402. The high-speed delay phase lock loop unit 426 is connected to the receiver unit 428 and the clock multiplier unit of the control unit 410. The full-speed delay phase lock loop and data recovery unit 424 is connected to the receiver unit 428 and the clock multiplier unit of the control unit 410. The clock multiplier unit of the control unit 410 is connected to the external oscillator unit 422 and the logical control unit of the control unit 408. The logical control unit of the control unit 408 is connected to the receiver unit 428 and transmit state control unit of the transceiver unit 418. The transmit register unit of the transceiver unit 416 is connected to the bit stuffer unit of the transceiver unit 414. The bit stuffer of the transceiver unit 414 is connected to the non-return-to-zero inverted decoder unit 420.

Although the present invention has been described with reference to the preferred embodiment thereof, it will be understood that the invention is not limited to the details thereof. Various substitutions and modifications have suggested in the foregoing description, and others will occur to those of ordinary skill in the art. Therefore, all such substitutions and modifications are intended to be embraced within the scope of the invention as defined in the appended claims.

1. A memory circuit design for an Universal Serial Bus (USB) 2.0 circuit architecture, comprising:
an analog front end unit;
a high-speed delay phase lock loop unit connected to the analog front end unit;
a full-speed delay phase lock loop and data recovery unit connected to the analog front end unit;
a receiver unit connected to the high-speed delay phase lock loop unit and the full-speed delay phase lock loop and data recovery unit;
a transceiver unit connected to the analog front end unit and the receiver unit;
a control unit connected to the transceiver unit, the receiver unit, the high-speed delay phase lock loop unit and the full-speed delay phase lock loop and data recovery unit; and
an external oscillator unit connected to the control unit.

2. The memory circuit as in claim 1, wherein the analog front end unit further comprises a high-speed transceiver unit and a full-speed transceiver unit.

3. The memory circuit as in claim 2, wherein the high-speed receiver unit is connected to the high-speed delay phase lock loop unit and the transceiver unit.

4. The memory circuit as in claim 2, wherein the full-speed transceiver unit is connected to the full-speed delay phase lock loop and data recovery unit and the transceiver unit.

5. The memory circuit as in claim 1, wherein the transceiver unit further comprises:
a transmit state control unit;
a transmit register unit;
a bit stuffer unit connect to the transmit register unit; and
a non-return-to-zero inverted (nrzi) decoder unit connected to the bit stuffer unit.

6. The memory circuit as in claim 5, wherein the transmit state control unit is connected to the control unit.

7. The memory circuit as in claim 5, wherein the non-return-to-zero inverted decoder unit is connected to the full-speed transceiver unit of the analog front end unit.

8. The memory circuit as in claim 5, wherein the transmit register unit is connected to the bit stuffer unit.

9. The memory circuit as in claim 1, wherein the control unit further comprises a clock multiplier unit and a logic control unit.

10. The memory circuit as in claim 9, wherein the clock multiplier unit is connected to the high-speed delay phase lock loop unit, the full-speed delay phase lock loop and date recovery unit and the external oscillator unit.

11. The memory circuit as in claim 9, wherein the logic control is connected to the clock multiplier unit, the receiver unit and the transmit state control unit of the transceiver unit.
